(19) United States
(12) Patent Application Publication
(10) Pub. No.: US 2026/0349887 A1
(43) Pub. Date: Nov. 5, 2026

(54) CXL MEMORY HOT-REPLACEMENT SYSTEM

(71) Applicant: Dell Products L.P., Round Rock, TX (US)

(72) Inventors: Raveendra Reddy Padala, Bangalore (IN); Manjunath Alaghatta Marulappa, Bangalore (IN); Rama Rao Bisa, Bangalore (IN); Raveendra Babu Madala, Agiripalli (IN); Jordan Hsiao Ping Chin, Austin, TX (US)

(21) Appl. No.: 19/198,831

(22) Filed: May 5, 2025

(51) Int. Cl. G06F 11/16; G06F 11/20

(52) U.S. Cl. CPC G06F 11/1612; G06F 11/1658; G06F 11/2033; G06F 11/16; G06F 11/1666; G06F 11/20; G06F 11/2023

(57) ABSTRACT

A CXL memory hot-replacement system includes a CXL switch device coupling a computing device to a CXL memory system including a first CXL memory device. The CXL switch device receives a hot-replacement request that identifies the first CXL memory device for hot-replacement and, in response, creates a hot-replacement partition in a storage subsystem. The CXL switch device then copies data present in the first CXL memory device to the hot-replacement partition while caching write instruction(s) received for the first CXL memory device and, following the completion of the data copying, executes the write instruction(s). The CXL switch device then receives a notification that the first CXL memory device has been replaced by a second CXL memory device and, in response, it copies the data from the hot-replacement partition to the second CXL memory device, and utilizes the second CXL memory device in the CXL memory system.

### BACKGROUND

The present disclosure relates generally to information handling systems, and more particularly to hot-replacement of CXL memory devices used by information handling systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, server devices and/or other computing devices known in the art, sometimes utilize external memory systems for the storage of their data. For example, Compute eXpress Link (CXL) memory devices may be used by a host device (e.g., the server devices discussed above) in situations where the memory and/or IO needs of the host device are not satisfied. As will be appreciated by one of skill in the art in possession of the present disclosure, CXL technologies and protocols enable access to a logical memory space provided by CXL memory devices as if they were present in the host device, and may include Type 1 CXL memory devices that provide a fully coherent cache and that are often used with accelerator devices (e.g., Smart Network Interface Controllers (SmartNICs), cache coherent devices, and other accelerator devices) with no local memory for low-latency and compute offload tasks such as compression, encryption, and network processing; Type 2 CXL memory devices that provide relatively high-bandwidth memory and that are often used with accelerator devices (Graphics Processing Units (GPUs), Field Programmable Gate Arrays (FPGAs), Artificial Intelligence (AI) accelerators, and other accelerator devices) with local memory for high bandwidth and low latency memory sharing while maintaining cache coherence between the accelerator device and Central Processing Unit (CPU) memory; and Type 3 memory devices that operate as expanded or pooled memory for the host device and that may be provided by Dynamic Random Access Memory (DRAM), CXL-based Non-Volatile Dual Inline Memory Modules (NVDIMMs) and/or other persistent memory, pooled memory modules, and/or other memory devices to allow scalability in memory-intensive applications such as large databases, AI workloads, and cloud computing.

However, the use of external memory systems like the CXL memory systems described above raises a number of issues. For example, CXL memory devices in a CXL memory system may require replacement periodically due to, for example, error issues (e.g., when the number of non-correctable errors in the CXL memory device exceeds a threshold), non-volatile power issues (e.g., when a battery in a CXL memory device that provides for non-volatile storage by that CXL memory device gets low on power or dies), and/or in other CXL memory device replacement scenarios that would be apparent to one of skill in the art in possession of the present disclosure. As will be appreciated by one of skill in the art in possession of the present disclosure, the replacement of a CXL memory device is time consuming and disruptive to its CXL memory system, as in order to replace a CXL memory device, a user power down the CXL memory system, replace the CXL memory device, and then power the CXL memory system back up, which results in the CXL memory system being unavailable to the server devices using it.

Accordingly, it would be desirable to provide a CXL memory system that addresses the issues discussed above.

### SUMMARY

According to one embodiment, an Information Handling System (IHS) includes a processing system; and a memory system that is coupled to the processing system and that includes instructions that, when executed by the processing system, cause the processing system to provide a Compute eXpress Logic (CXL) memory hot-replacement engine that is configured to: receive a hot-replacement request that identifies a first CXL memory device in a CXL memory system for hot-replacement; create, in response to receiving the hot-replacement request, a hot-replacement partition in a storage subsystem that is coupled to the processing system; copy data present in the first CXL memory device to the hot-replacement partition; cache, while copying the data present in the first CXL memory device to the hot-replacement partition, one or more write instructions received for the first CXL memory device; execute, in the hot-replacement partition following the completion of the copying of the data present in the first CXL memory device to the hot-replacement partition, the one or more write instructions that were received for the first CXL memory device and cached; receive a first hot-replacement notification that the first CXL memory device has been replaced by a second CXL memory device; copy, in response to receiving the first hot-replacement notification, the data from the hot-replacement partition to the second CXL memory device; and utilize the second CXL memory device in the CXL memory system.

### BRIEF DESCRIPTION OF THE DRAWINGS

FIG. 1 is a schematic view illustrating an embodiment of an Information Handling System (IHS).

FIG. 2 is a schematic view illustrating an embodiment of a CXL memory hot-replacement system that may be provided according to the teachings of the present disclosure.

FIG. 3 is a schematic view illustrating an embodiment of the CXL memory hot-placement system of FIG. 2.

FIG. 4 is a schematic view illustrating an embodiment of the CXL memory hot-placement system of FIG. 2.

FIG. 5 is a schematic view illustrating an embodiment of the CXL memory hot-placement system of FIG. 2.

FIG. 6 is a schematic view illustrating an embodiment of the CXL memory hot-placement system of FIG. 2.

FIG. 7A is a flow chart illustrating an embodiment of a portion of a method for hot-replacing CXL memory.

FIG. 7B is a flow chart illustrating an embodiment of a portion of a method for hot-replacing CXL memory.

FIG. 8A is a schematic view illustrating an embodiment of the CXL memory hot-replacement system of FIG. 2 operating during the method of FIG. 7.

FIG. 8B is a schematic view illustrating an embodiment of the CXL memory hot-replacement system of FIG. 2 operating during the method of FIG. 7.

FIG. 9 is a schematic view illustrating an embodiment of the CXL memory hot-replacement system of FIG. 2 operating during the method of FIG. 7.

FIG. 10A is a schematic view illustrating an embodiment of the CXL memory hot-replacement system of FIG. 2 operating during the method of FIG. 7.

FIG. 10B is a schematic view illustrating an embodiment of the CXL memory hot-replacement system of FIG. 2 operating during the method of FIG. 7.

FIG. 11 is a schematic view illustrating an embodiment of the CXL memory hot-replacement system of FIG. 2 operating during the method of FIG. 7.

FIG. 12A is a schematic view illustrating an embodiment of the CXL memory hot-replacement system of FIG. 2 operating during the method of FIG. 7.

FIG. 12B is a schematic view illustrating an embodiment of the CXL memory hot-replacement system of FIG. 2 operating during the method of FIG. 7.

FIG. 13A is a schematic view illustrating an embodiment of the CXL memory hot-replacement system of FIG. 2 operating during the method of FIG. 7.

FIG. 13B is a schematic view illustrating an embodiment of the CXL memory hot-replacement system of FIG. 2 operating during the method of FIG. 7.

FIG. 13C is a schematic view illustrating an embodiment of the CXL memory hot-replacement system of FIG. 2 operating during the method of FIG. 7.

FIG. 14A is a schematic view illustrating an embodiment of the CXL memory hot-replacement system of FIG. 2 operating during the method of FIG. 7.

FIG. 14B is a schematic view illustrating an embodiment of the CXL memory hot-replacement system of FIG. 2 operating during the method of FIG. 7.

FIG. 15 is a schematic view illustrating an embodiment of the CXL memory hot-replacement system of FIG. 2 operating during the method of FIG. 7.

FIG. 16 is a schematic view illustrating an embodiment of the CXL memory hot-replacement system of FIG. 2 operating during the method of FIG. 7.

FIG. 17 is a schematic view illustrating an embodiment of the CXL memory hot-replacement system of FIG. 2 operating during the method of FIG. 7.

FIG. 18 is a schematic view illustrating an embodiment of the CXL memory hot-replacement system of FIG. 2 operating during the method of FIG. 7.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

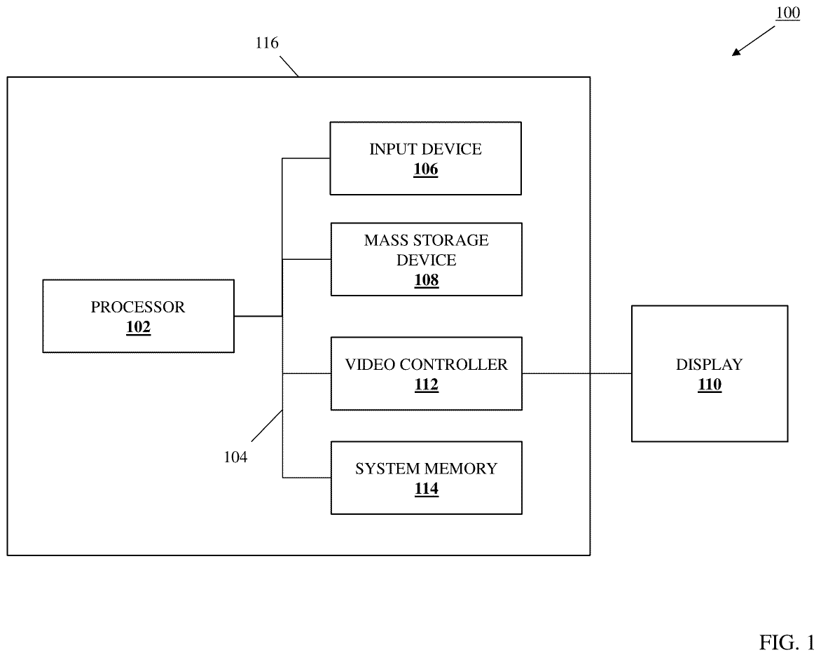

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

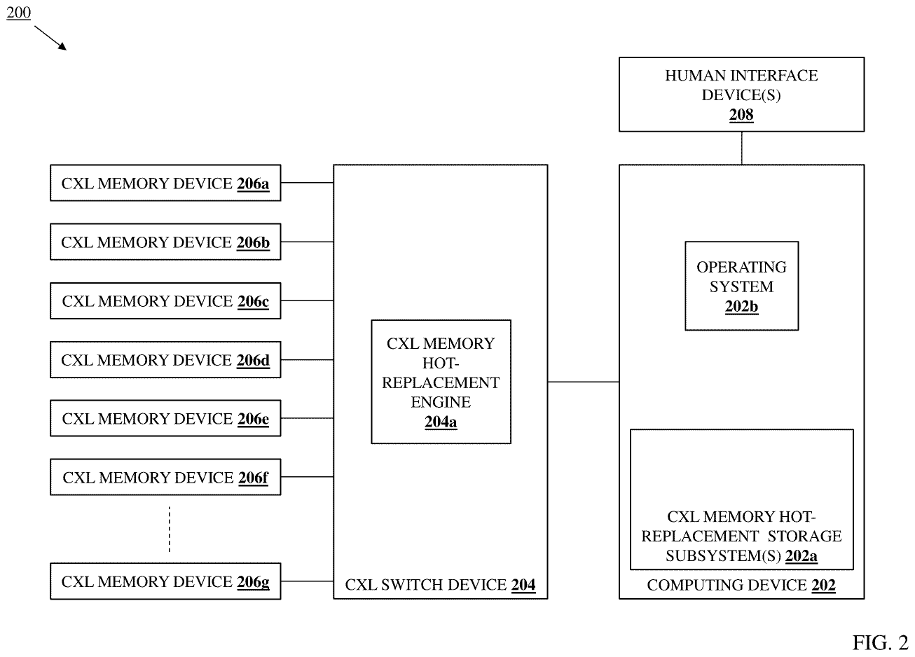

Referring now to FIG. 2, an embodiment of a CXL memory hot-replacement system 200 is illustrated that may be provided according to the teachings of the present disclosure. In the illustrated embodiment, the CXL memory hot-replacement system 200 includes a computing device 202. In an embodiment, the computing device 202 may be provided by the IHS 100 discussed above with reference to FIG. 1, and/or may include some or all of the components of the IHS 100, and in specific examples may be provided by a server device. However, while described as being provided by a server device, one of skill in the art in possession of the present disclosure will appreciate how the computing device 202 may be provided by a variety of other computing devices while remaining within the scope of the present disclosure as well.

In the illustrated embodiments, the computing device 202 includes one or more CXL memory hot-replacement storage subsystems 202a that, as described below, may be provided by non-volatile memory device(s), Solid State Drive (SSD) storage device(s), Hard Disk Drive (HDD) storage device(s), and/or any other storage subsystems that would be apparent to one of skill in the art in possession of the present disclosure. However, while illustrated and described as being included in the computing device 202, one of skill in the art in possession of the present disclosure will appreciate how the CXL memory hot-replacement storage subsystem 202a may be provided outside of the computing device 202, may be coupled to the computing device 202, and/or may otherwise be accessible to the computing device 202 without being included in the computing device 202 while remaining within the scope of the present disclosure.

The computing device 202 may also include a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide an operating system engine that is configured to provide an operating system 202b that is configured to perform the functionality of the operating systems and/or computing devices discussed below. However, while a specific computing device 202 is illustrated and described below as using CXL memory devices in the CXL memory hot-replacement system 200 of the present disclosure, one of skill in the art in possession of the present disclosure will appreciate how a variety of computing devices may utilize CXL memory devices similarly as described below while remaining within the scope of the present disclosure as well.

In the embodiment illustrated in FIG. 2, the computing device 202 is coupled to a CXL switch device 204, but as described below some embodiments of the present disclosure may provide the CXL switch device 204 in the computing device 202. As illustrated, the CXL switch device 204 may include a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide a CXL memory hot-replacement engine 204a that is configured to perform the functionality of the CXL memory hot-replacement engines and/or CXL switch devices discussed below.

As illustrated, a CXL memory system includes a plurality of CXL memory devices 206a, 206b, 206c, 206d, 206e, 206f, and up to 206g that are coupled to the CXL switch device 204. As described above, the CXL memory devices 206a-206g may include Type 1 CXL memory devices that provide a fully coherent cache and that are often used with accelerator devices (e.g., Smart Network Interface Controllers (SmartNICs), cache coherent devices, and other accelerator devices) with no local memory for low-latency and compute offload tasks such as compression, encryption, and network processing; Type 2 CXL memory devices that provide relatively high-bandwidth memory and that are often used with accelerator devices (Graphics Processing Units (GPUs), Field Programmable Gate Arrays (FPGAs), Artificial Intelligence (AI) accelerators, and other accelerator devices) with local memory for high bandwidth and low latency memory sharing while maintaining cache coherence between the accelerator device and Central Processing Unit (CPU) memory; and/or Type 3 memory devices that operate as expanded or pooled memory for the host device and that may be provided by Dynamic Random Access Memory (DRAM), CXL-based Non-Volatile Dual Inline Memory Modules (NVDIMMs) and/or other persistent memory, pooled memory modules, and/or other memory devices to allow scalability in memory-intensive applications such as large databases, AI workloads, and cloud computing

In some embodiments, one or more human interface devices 208 may be coupled to the computing device 202 and, as described below, may be provided by input devices (e.g., mouse devices, keyboard devices, etc.), display devices, Graphical User Interfaces (GUIs), and/or any other human interface devices that would be apparent to one of skill in the art in possession of the present disclosure. However, while a specific CXL memory hot-replacement system 200 has been illustrated and described, one of skill in the art in possession of the present disclosure will recognize that the CXL memory hot-replacement system (or other devices operating according to the teachings of the present disclosure in a manner similar to that described below for the CXL memory hot-replacement system 200) may include a variety of components and/or component configurations for providing conventional CXL memory system functionality, as well as the CXL memory hot-replacement functionality discussed below, while remaining within the scope of the present disclosure as well.

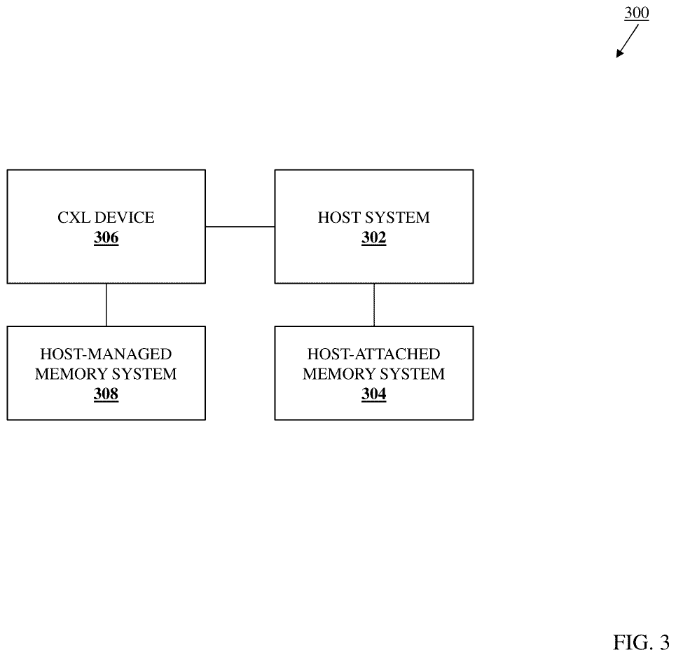

Referring now to FIG. 3, an embodiment of a Compute eXpress Logical (CXL) memory system 300 is illustrated that may provide the CXL memory hot-replacement system 200 discussed above with reference to FIG. 2. In the illustrated embodiment, the CXL memory system 300 includes a host system 302 that may be provided by a processing system in a host device such as the server devices/computing devices discussed above. As will be appreciated by one of skill in the art in possession of the present disclosure and as described below, the host system 302 may include a root complex having a memory controller, a host/home agent, an IO bridge having an IO Memory Management Unit (IOMMU), as well as any other host system components known in the art. As illustrated, the host system 302 may include a “host-attached” memory system 304 that one of skill in the art in possession of the present disclosure will appreciate may be provided by memory devices in the server device/computing device that includes the host system 302. A CXL device 306 is coupled to the host system 302 and a “host-managed” memory system 308 that may include any of a variety of memory devices that are external to the server device/computing device that includes the host system 302, with the CXL device 306 and host-managed memory system 308 providing the CXL switch device 204 and CXL memory devices 206a-206g discussed above with reference to FIG. 2.

As will be appreciated by one of skill in the art in possession of the present disclosure, the host system 302 may utilize the host-attached memory system 304 via the memory controller in its root complex and using any of a variety of conventional techniques known in the art, and may utilize the hot-managed memory system 308 through the CXL device 306 via the host/home agent in its root complex. To provide a specific example in which the CXL device 306 is a Type 3 CXL device provided by a CXL memory expander, the IOMMU of the IO bridge in the root complex of the host system 302 may utilize the CXL.io protocol to communicate with the CXL memory expander to discover, enumerate, and configure the host-managed memory system 308, while the host/home agent in the root complex of the host system 302 may use the CXL.mem protocol to communicate with the CXL memory expander to utilize the host-managed memory system 308.

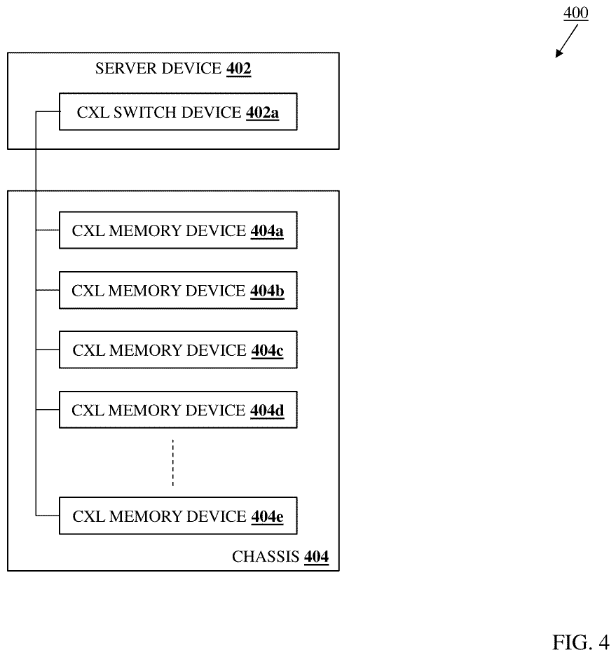

With reference to FIG. 4, a specific example of a CXL memory system 400 is illustrated that may include the CXL memory system 300 of FIG. 3 and may provide the CXL memory hot-replacement system 200 discussed above. The CXL memory system 400 includes a server device 402 that may be provided by the computing device 202 of FIG. 2 and may include the host system 302 of FIG. 3, with the server device 402 including a CXL switch device 402a that provides the CXL device 306 of FIG. 3 and the CXL switch device 204 of FIG. 2. The CXL memory system 400 also includes a chassis 404 that one of skill in the art in possession of the present disclosure will recognize is provided by a “Just a Bunch Of Memory” (JBOM) chassis that houses a plurality of CXL memory devices 404a, 404b, 404c, 404d, and up to 404f that are coupled to the CXL switch device 402a and that provide the host-managed memory system 308 of FIG. 3 and the CXL memory devices 206a-206g of FIG. 2. As will be appreciated by one of skill in the art in possession of the present disclosure, the server device 402 may utilize the CXL switch device 402a to access logical memory space(s) and/or other logical storage systems provided by any combination of the CXL memory devices 404a-404e.

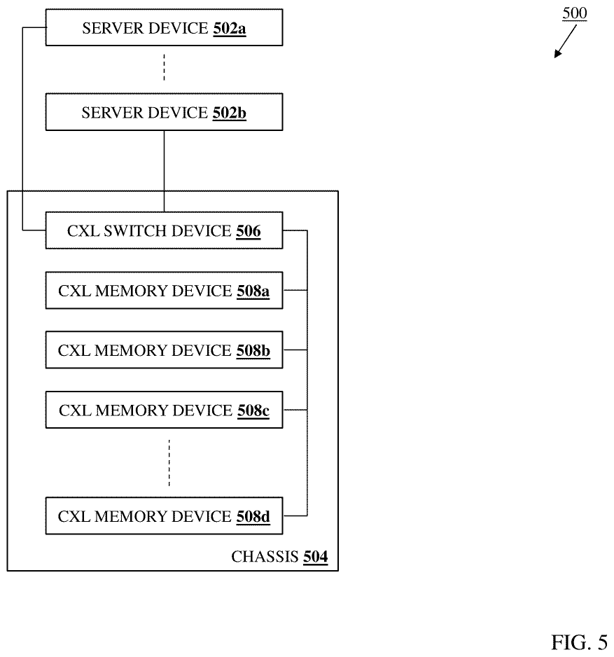

With reference to FIG. 5, another specific example of a CXL memory system 500 is illustrated that may include the CXL memory system 300 of FIG. 3 and may provide the CXL memory hot-replacement system 200 discussed above. The CXL memory system 500 includes a plurality of server devices 502a and up to 502b that may each be provided by the computing device 202 of FIG. 2 and that may each include a respective host system that is similar to the host system 302 of FIG. 3. The CXL memory system 500 also includes a chassis 504 that one of skill in the art in possession of the present disclosure will recognize is provided by a “Just a Bunch Of Memory” (JBOM) chassis that houses a CXL switch device 506 that provides the CXL device 306 of FIG. 3 and the CXL switch device 204 of FIG. 2, and a plurality of CXL memory devices 508a, 508b, 508c, and up to 508d that are coupled to the CXL switch device 506 and that provide the host-managed memory system 308 of FIG. 3 and the CXL memory devices 206a-206g of FIG. 2. As will be appreciated by one of skill in the art in possession of the present disclosure, any of the server devices 502a-502b may utilize the CXL switch device 506 to access logical memory space(s) and/or other logical storage systems provided by any combination of the CXL memory devices 508a-508d.

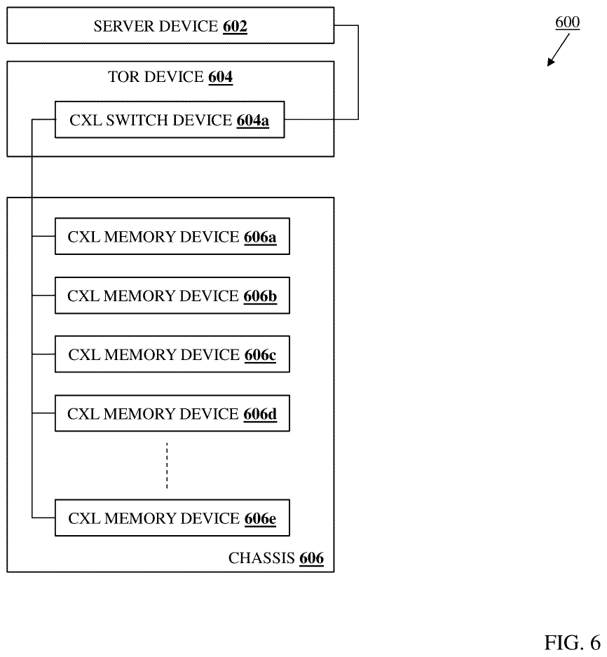

With reference to FIG. 6, another specific example of a CXL memory system 600 is illustrated that may include the CXL memory system 300 of FIG. 3 and may provide the CXL memory hot-replacement system 200 discussed above. The CXL memory system 600 includes a server device 602 that may provide the computing device 202 of FIG. 2 and that may include the host system 302 of FIG. 3. The CXL memory system 600 also includes a Top Of Rack (TOR) device 604 having a CXL switch device 604a that provides the CXL device 306 of FIG. 3 and the CXL switch device 204 of FIG. 2, and that is coupled to the server device 602. The CXL memory system 600 also includes a chassis 606 that one of skill in the art in possession of the present disclosure will recognize is provided by a “Just a Bunch Of Memory” (JBOM) chassis that houses a plurality of CXL memory devices 606a, 606b, 606c, 606d, and up to 606e that are each coupled to the CXL switch device 604a and that provide the host-managed memory system 308 of FIG. 3 and the CXL memory devices 206a-206g of FIG. 2. As will be appreciated by one of skill in the art in possession of the present disclosure, the server device 602 may utilize the CXL switch device 506 in the TOR device 604 to access logical memory space(s) and/or other logical storage systems provided by any combination of the CXL memory devices 606a-606e.

However, while several different examples of the CXL memory hot-replacement system of the present disclosure have been illustrated and described, one of skill in the art in possession of the present disclosure will appreciate how CXL memory devices and CXL switch devices may be configured in a variety of manners that will enable the CXL memory hot-replacement functionality described below.

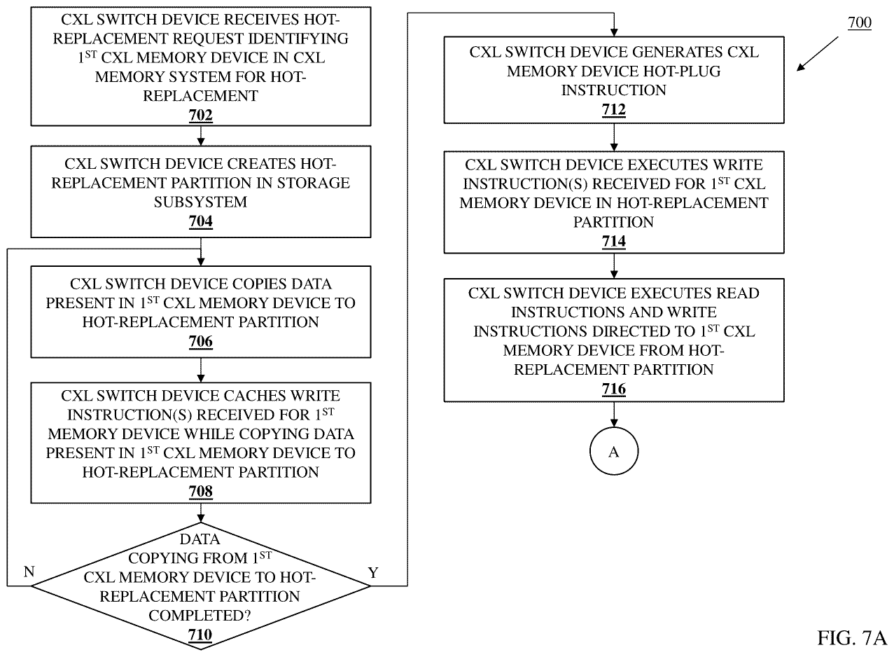

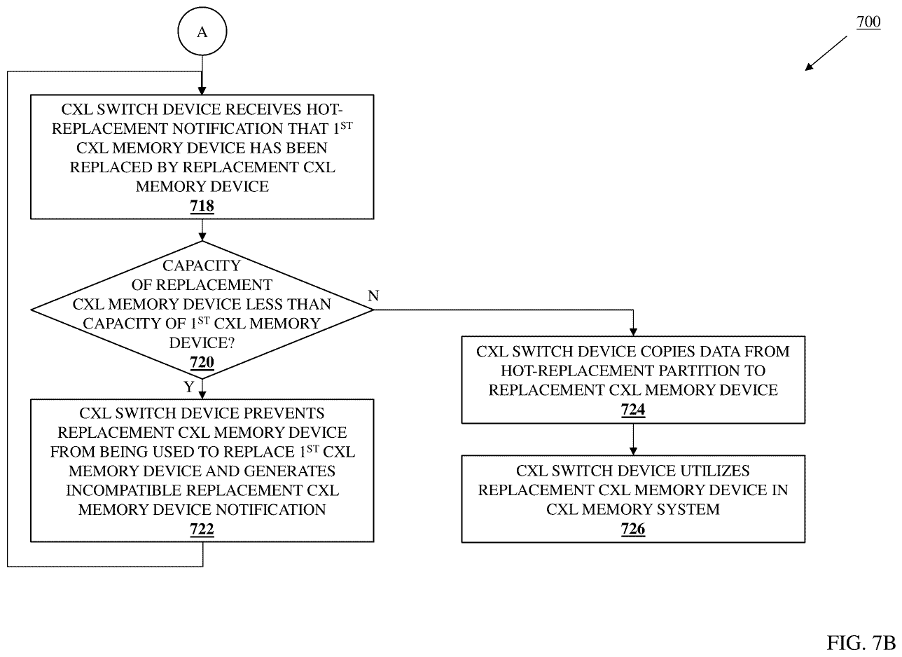

Referring now to FIGS. 7A and 7B, an embodiment of a method 700 for hot-replacing CXL memory is illustrated. As discussed below, the systems and methods of the present disclosure provide for the “hot-replacement” of CXL memory devices in a CXL memory system. For example, the CXL memory hot-replacement system of the present disclosure may include a CXL switch device coupling a computing device to a CXL memory system including a first CXL memory device. The CXL switch device receives a hot-replacement request that identifies the first CXL memory device for hot-replacement and, in response, creates a hot-replacement partition in a storage subsystem. The CXL switch device then copies data present in the first CXL memory device to the hot-replacement partition while caching write instruction(s) received for the first CXL memory device and, following the completion of the data copying, executes the write instruction(s). The CXL switch device then receives a notification that the first CXL memory device has been replaced by a second CXL memory device and, in response, it copies the data from the hot-replacement partition to the second CXL memory device, and utilizes the second CXL memory device in the CXL memory system. As such, CXL memory devices in a CXL memory system may be replaced faster than in conventional CXL memory systems and while providing no disruptions to workloads using the CXL memory system.

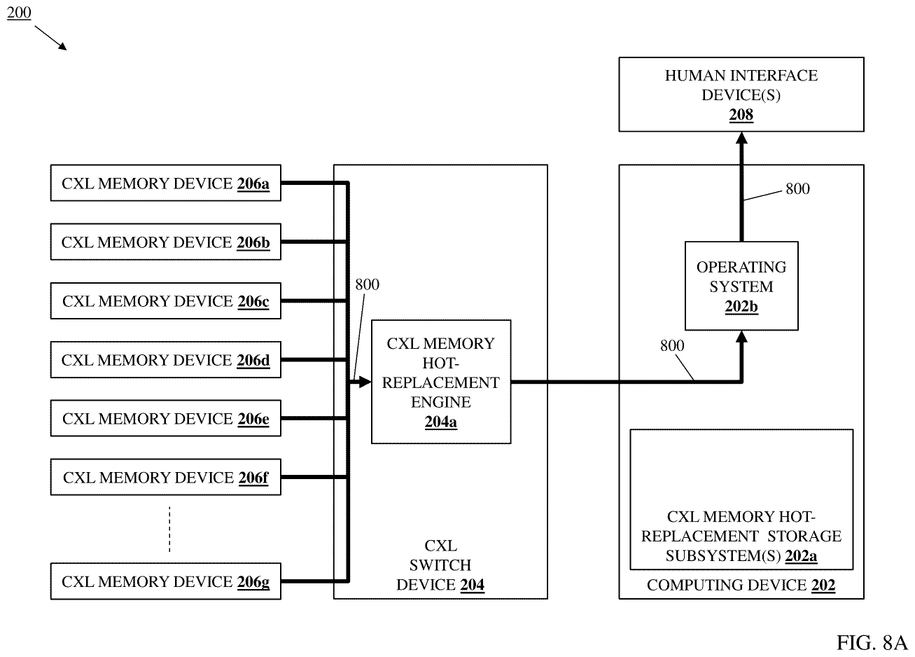

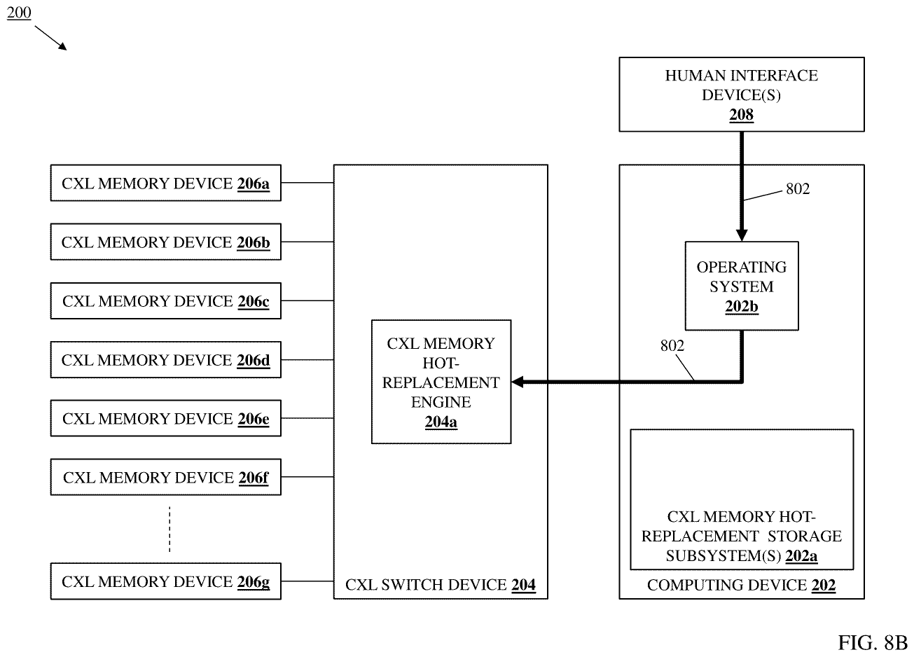

The method 700 begins at block 702 where a CXL switch device receives a hot-replacement request identifying a first CXL memory device in a CXL memory system for hot-replacement. With reference to FIG. 8A, in an embodiment of block 702, the CXL memory hot-replacement engine 204a in the CXL switch device 204 may perform CXL memory device identification operations 800 that may include retrieving CXL memory device identification information for the CXL memory devices 206a-206g and providing that CXL memory device identification information to the operating system 202b to cause the operating system 202b to provide that CXL memory device identification information for display to a user on the human interface device(s) 208.

For example, the operating system 202b may provide the CXL memory device identification information for display to the user via a CXL memory management Graphical User Interface (GUI) that is provided on a display device included in the human interface device(s) 208, with the CXL memory device identification information identifying each of the CXL memory devices 206a-206g in the CXL memory system and allowing a use to select any of those CXL memory devices for the hot-replacement discussed below, as well as to perform any other CXL memory system management operations that would be apparent to one of skill in the art in possession of the present disclosure. As discussed above, CXL memory devices in a CXL memory system may require replacement periodically due to, for example, error issues (e.g., when the number of non-correctable errors in the CXL memory device exceeds a threshold), non-volatile power issues (e.g., when a battery in a CXL memory device that provides for non-volatile storage by that CXL memory device gets low on power or dies), and/or in other CXL memory device replacement scenarios that would be apparent to one of skill in the art in possession of the present disclosure, and thus the user may use the CXL memory management GUI to select any of the CXL memory devices 206a-206g for hot-replacement due to any of those issues.

With reference to FIG. 8B, in an embodiment of block 702, the CXL memory hot-replacement engine 204a in the CXL switch device 204 may then perform hot-replacement request receiving operations 802 that include receiving a hot-replacement request for one of the CXL memory devices 206a-206g from the human interface device(s) 208 via the operating system 202b. For example, a user may utilize the CXL memory management GUI described above to select one of the CXL memory devices 206a-206g in the CXL memory system for the hot-replacement, and one of skill in the art in possession of the present disclosure will appreciate how the “hot-replacement” of a CXL memory device may refer to the removal of a first CXL memory device from the CXL memory system (e.g., the disconnection (i.e., the “hot removal”) of the first CXL memory device from a first CXL memory device slot) and the replacement of the first CXL memory device with a second CXL memory device (e.g., the connection (i.e., the “hot plugging”) of the second CXL memory device to the first CXL memory device slot) without powering down the CXL memory system or otherwise making the CXL memory system unavailable such that it may continue to be utilized by workload(s) running on computing device(s), as well as to any other hot-replacement operations that would be apparent to one of skill in the art in possession of the present disclosure.

In the examples below, the CXL memory device 206b is identified at block 702 for hot-placement, but one of skill in the art in possession of the present disclosure will appreciate how any of the CXL memory devices 206a and 206c-206g may be hot-replaced similarly as described below for the CXL memory device 206b while remaining within the scope of the present disclosure as well.

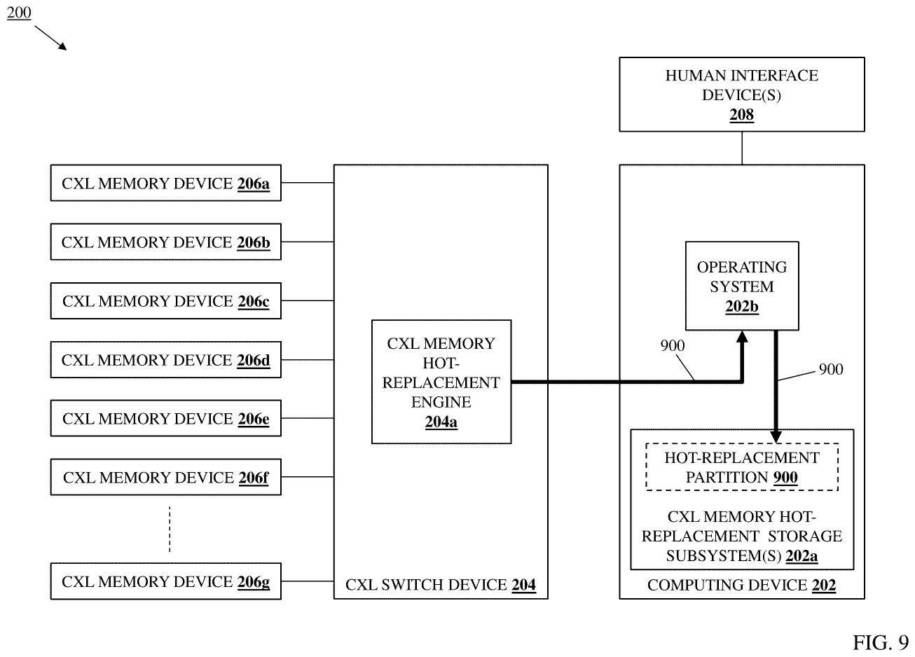

The method 700 then proceeds to block 704 where the CXL switch device creates a hot-replacement partition in a storage subsystem. With reference to FIG. 9, in an embodiment of block 704, the CXL memory hot-replacement engine 204a in the CXL memory device 204 may perform hot-replacement partition creation operations 900 that include creating a hot-replacement partition 900 in the CXL memory hot-replacement storage subsystem(s) 202a. As described above, the CXL memory hot-replacement storage subsystem 202a that is used to create the hot-replacement partition 900 may be provided by non-volatile memory device(s), SSD storage device(s), or HDD storage device(s), and in some embodiments the CXL memory hot-replacement engine 204a may prioritize creating the hot-replacement partition 900 in non-volatile memory devices over SSD storage devices and HDD storage devices, and may prioritize creating the hot-replacement partition 900 in SSD storage devices over HDD storage devices, in order to attempt to provide the highest possible Input/Output (IO) speeds when using the hot-replacement partition 900.

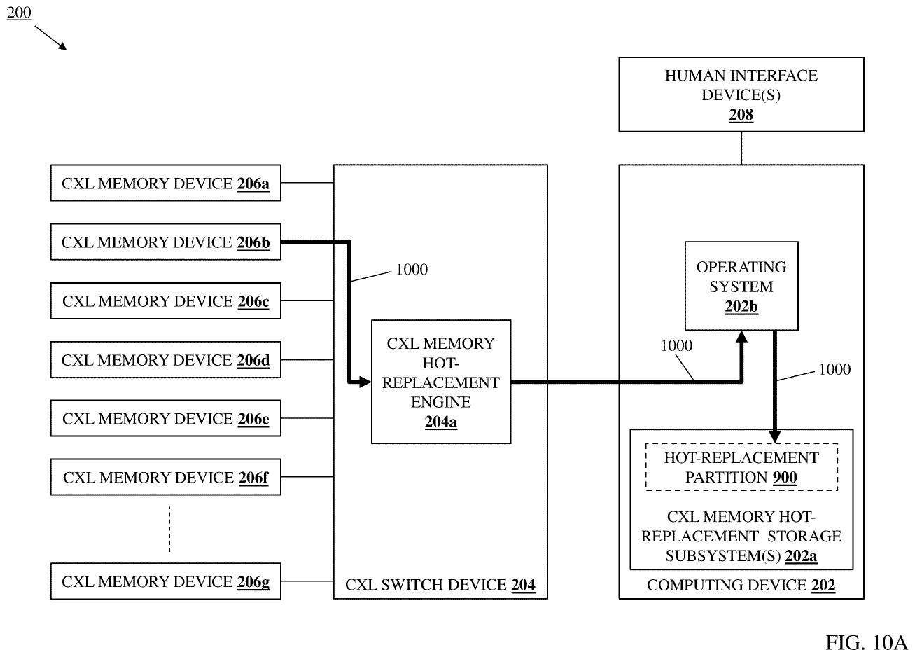

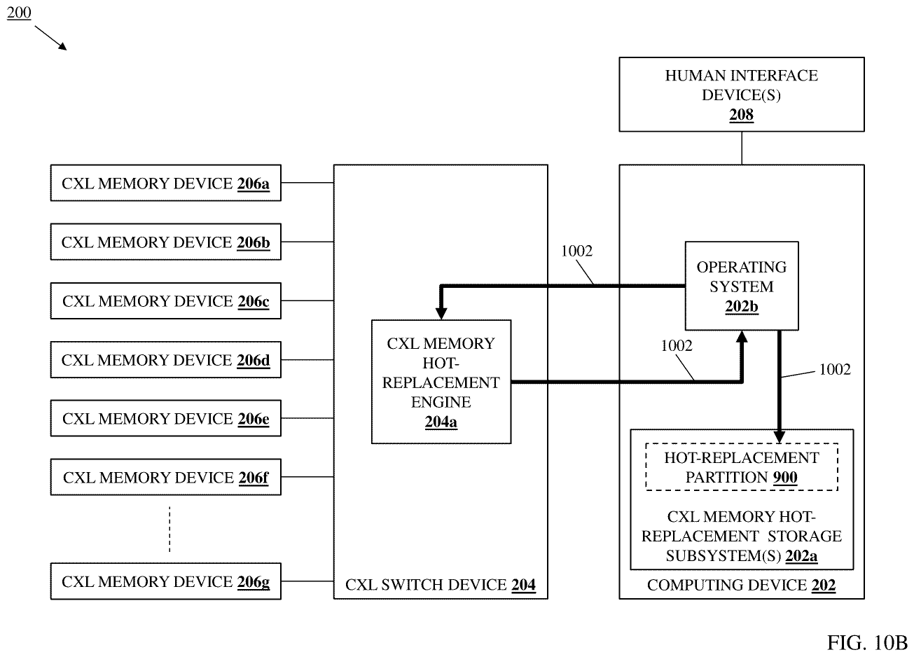

The method 700 then proceeds to block 706 where the CXL switch device copies data present in the first CXL memory device to the hot-replacement partition. With reference to FIG. 10A, in an embodiment of block 706, the CXL memory hot-replacement engine 204a in the CXL memory device 204 may begin the performance of data copy operations 1000 that include reading the data present on the CXL memory device 206b, and transmitting that data to the operating system 202b to cause the operating system 202b to write that data to the hot-replacement partition 900 in the CXL memory hot-replacement storage subsystem(s) 202a.

The method 700 then proceeds to block 708 where the CXL switch device caches one or more write instructions received for the first CXL memory device while copying the data present in the first CXL memory device to the hot-replacement partition. With reference to FIG. 10B, in an embodiment of block 708 and during the performance of the data copying operations 1000 discussed above with reference to block 706, the CXL memory hot-replacement engine 204a in the CXL memory device 204 may perform write caching operations 1002 that may include receiving write instruction(s) that may be directed to the CXL memory device 206b via the operating system 202b from a workload running on the computing device 202, and transmitting those write instruction(s) to the operating system 202b to cause the operating system 202b to cache the write instruction(s) in the hot-replacement partition 900. However, while the illustrated example provides for the caching of the write instruction(s) received for the CXL memory device 206b in the hot-replacement partition 900, one of skill in the art in possession of the present disclosure will appreciate how the write instruction(s) received for the CXL memory device 206b may be cached in other storage subsystems included in or coupled to the computing device 202 while remaining within the scope of the present disclosure as well.

The method 700 then proceeds to decision block 710 where the method 700 proceeds depending on whether the data copying from the first CXL memory device to the hot-replacement partition has been completed. As will be appreciated by one of skill in the art in possession of the present disclosure, as part of the performance of block 706 the CXL switch device 204 will continue copying of the data present in the CXL memory device 206b to the hot-replacement partition 900 until all of the data present in the CXL memory device 206b has been copied to the hot-replacement partition 900. If, at decision block 710, the data copying from the first CXL memory device to the hot-replacement partition has not been completed, the method 700 returns to block 706. As such, the method 700 may loop such that the CXL switch device 204 continues copying the data present in the CXL memory device 206b to the hot-replacement partition 900 and caching write instruction(s) received for the CXL memory device 206b until the copying of the data present in the CXL memory device 206b to the hot-replacement partition 900 has been completed.

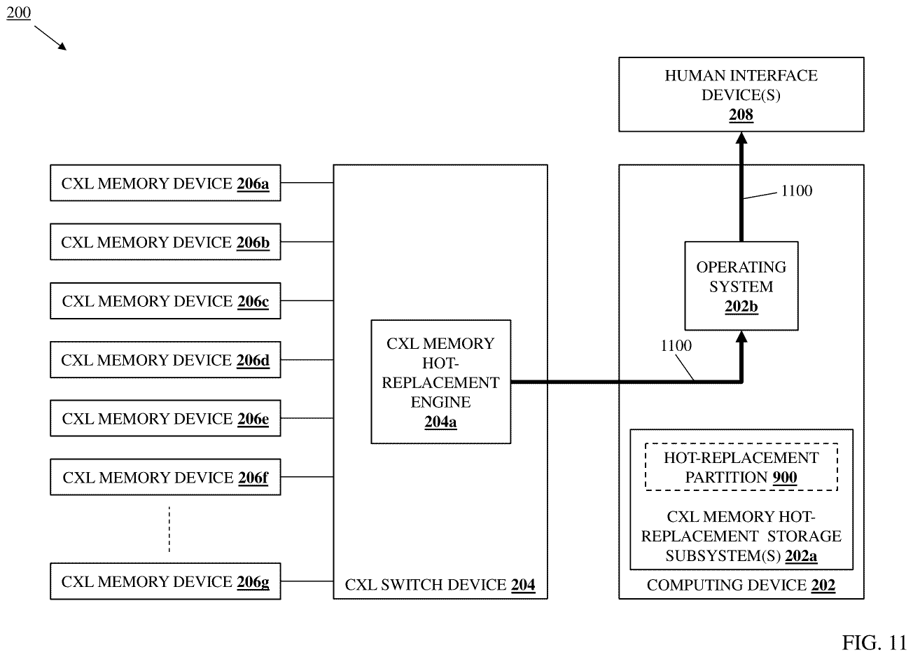

If, at decision block 710, the data copying from the first CXL memory device to the hot-replacement partition has been completed, the method 700 proceeds to block 712 where the CXL memory device generates a CXL memory device hot-plug instruction. With reference to FIG. 11, in an embodiment of block 712 and following the completion of the copying of the data present in the CXL memory device 206b to the hot-replacement partition 900, the CXL memory hot-replacement engine 204a in the CXL memory device 204 may perform hot-plug instruction provisioning operations 1100 that may include generating a hot-plug instruction, and transmitting the hot-plug instruction to the operating system 202b to cause the operating system 202b to transmit that hot-plug instruction to the human interface device(s) 208. For example, the operating system 202b may provide the hot-plug instruction for display to a user via the CXL memory management GUI discussed above (e.g., the CXL memory management GUI used to provide the hot-replacement request), with the hot-plug instruction instructing the user to remove the CXL memory device 206b from the CXL memory system and replace it with a replacement CXL memory device, as well as any other hot-plug instructions that would be apparent to one of skill in the art in possession of the present disclosure.

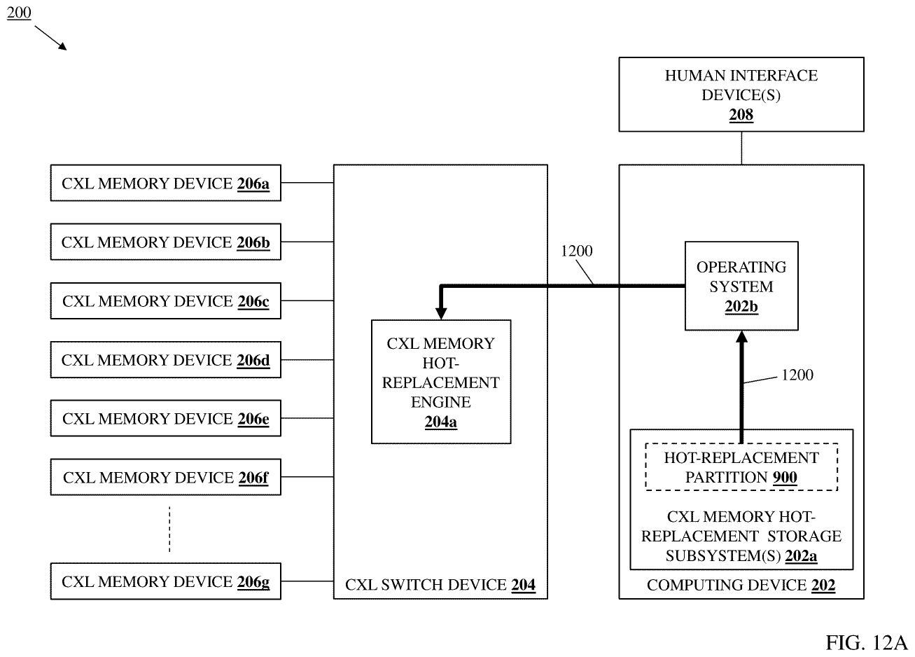

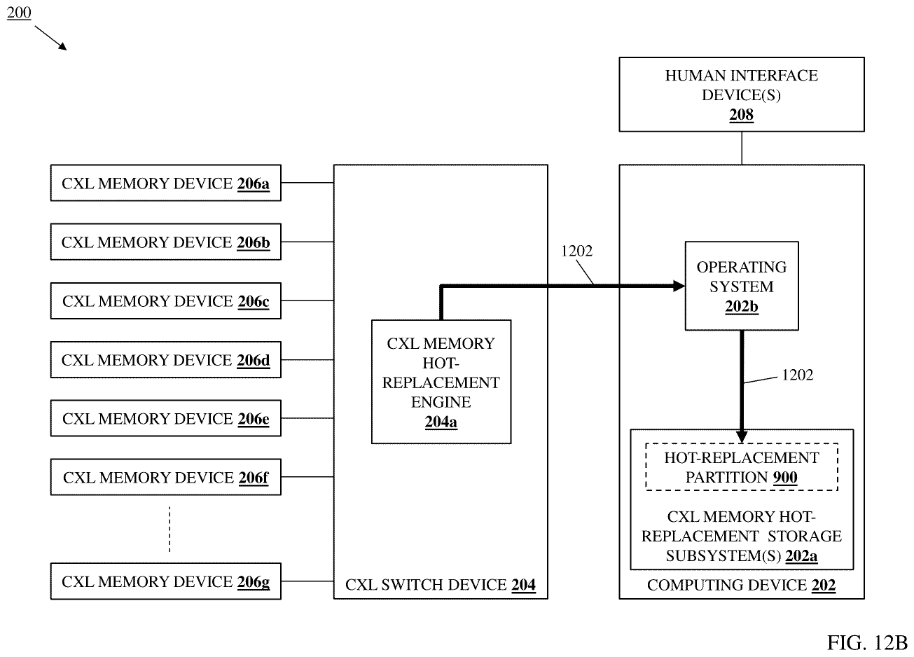

The method 700 then proceeds to block 714 where the CXL switch device executes the one or more write instructions that were received for the first CXL memory device in the hot-replacement partition. With reference to FIGS. 12A and 12B, in an embodiment of block 714 and following the completion of the copying of the data present in the CXL memory device 206b to the hot-replacement partition 900, the CXL memory hot-replacement engine 204a in the CXL memory device 204 may perform cached write instruction retrieval operations 1200 that may include retrieving the write instruction(s), which were received for the CXL memory device 206b and cached in the hot-replacement partition 900, from the hot-replacement partition 900 via the operating system 202b. The CXL memory hot-replacement engine 204a in the CXL memory device 204 may then perform write instruction execution operations 1202 that may include executing those write instruction(s) by transmitting those write instructions to the operating system 202b to cause the operating system 202b to execute those write instructions in the hot-replacement partition 900.

As will be appreciated by one of skill in the art in possession of the present disclosure, any write instruction transmitted to the operating system 202b at block 714 may be substantially similar to the corresponding write instruction received and cached at block 708 (i.e., those write instructions may include the same data), with the exception that the write instruction transmitted to the operating system 202b directs the writing of data to the hot-replacement partition 900 rather than the CXL memory device 206b).

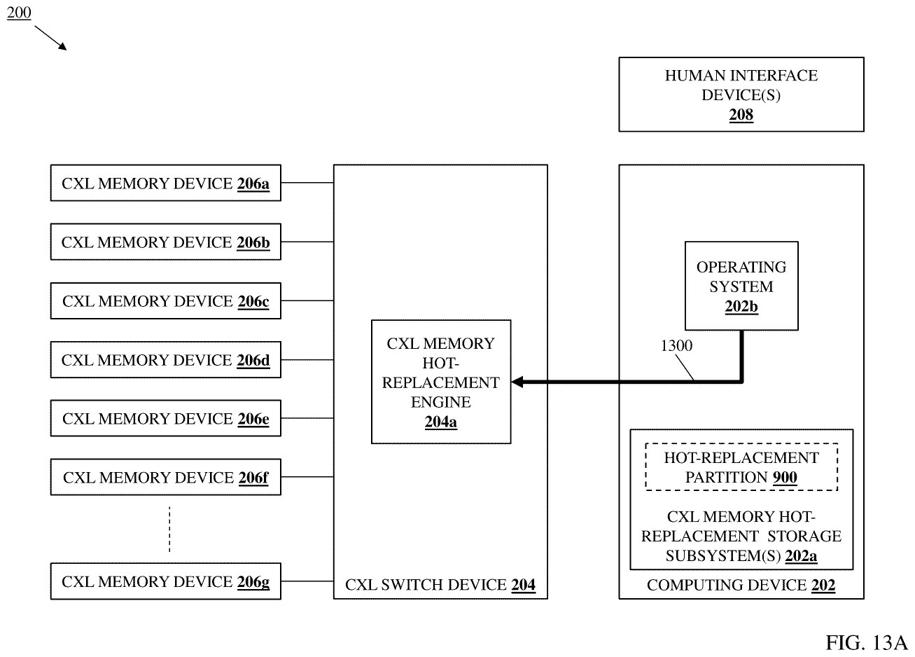

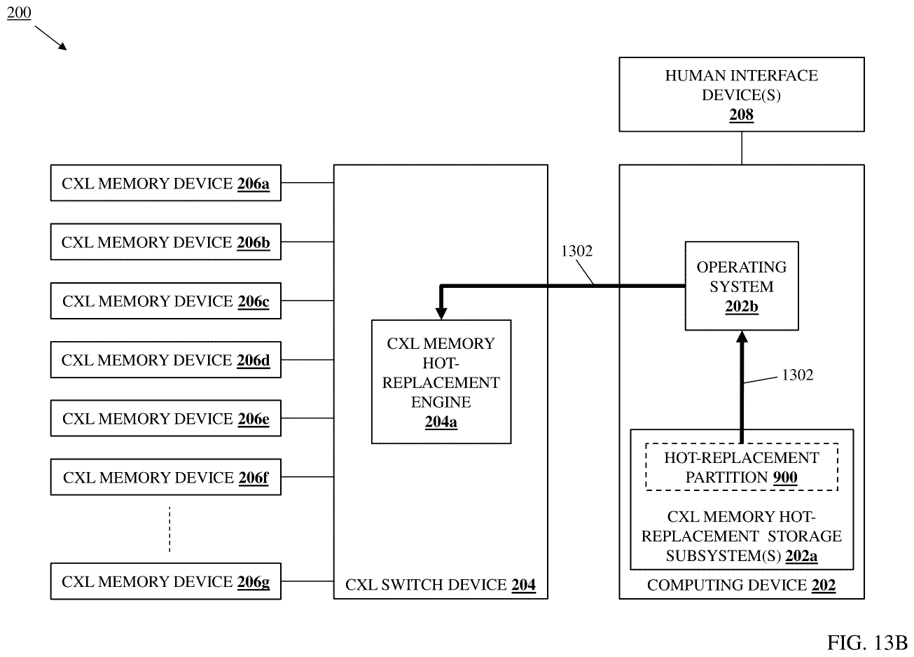

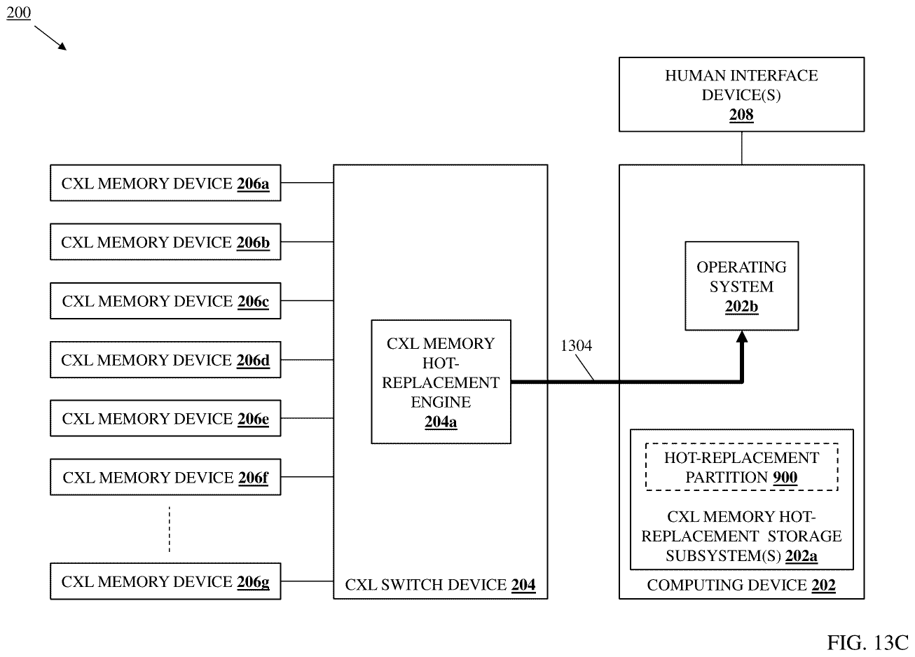

The method 700 then proceeds to block 716 where the CXL switch device executes read instructions and write instructions directed to the first CXL memory device from the hot-replacement partition. With reference to FIG. 13A, in an embodiment of block 716 and following the completion of the execution of the cached write instruction in the hot-placement partition 900, the CXL memory hot-replacement engine 204a in the CXL switch device 204 may perform read instruction receiving operations 1300 that may include receiving read instructions from the operating system 202b that are directed to the CXL memory device 206b, and one of skill in the art in possession of the present disclosure will appreciate how workload(s) running on the computing device 202 may utilize the operating system 202b to direct read instructions to the CXL memory device 206b. With reference to FIG. 13B, at block 706 and in response to receiving the read instructions, the CXL memory hot-replacement engine 204a in the CXL switch device 204 may perform data retrieval operations 1302 that may include retrieving data identified in the read instruction from the hot-replacement partition 900 via the operating system 202b. With reference to FIG. 13C, at block 706 and in response to retrieving the data identified by the read instructions, the CXL memory hot-replacement engine 204a in the CXL switch device 204 may perform data transmission operations 1304 that may include transmitting the data retrieved from the hot-replacement partition 900 to the operating system 202b so that the operating system 202b may provide that data to the workload that provided the read instruction.

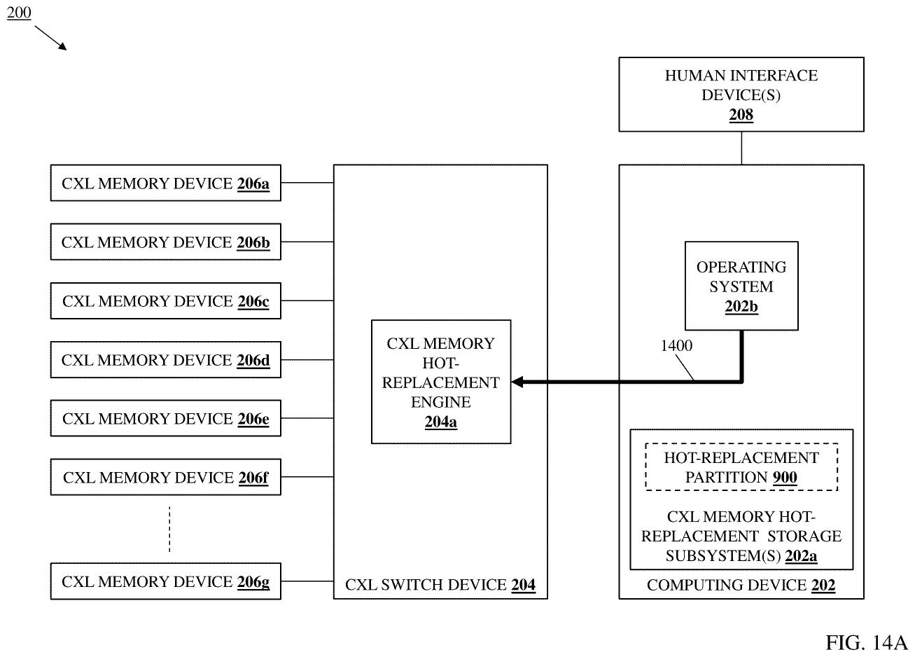

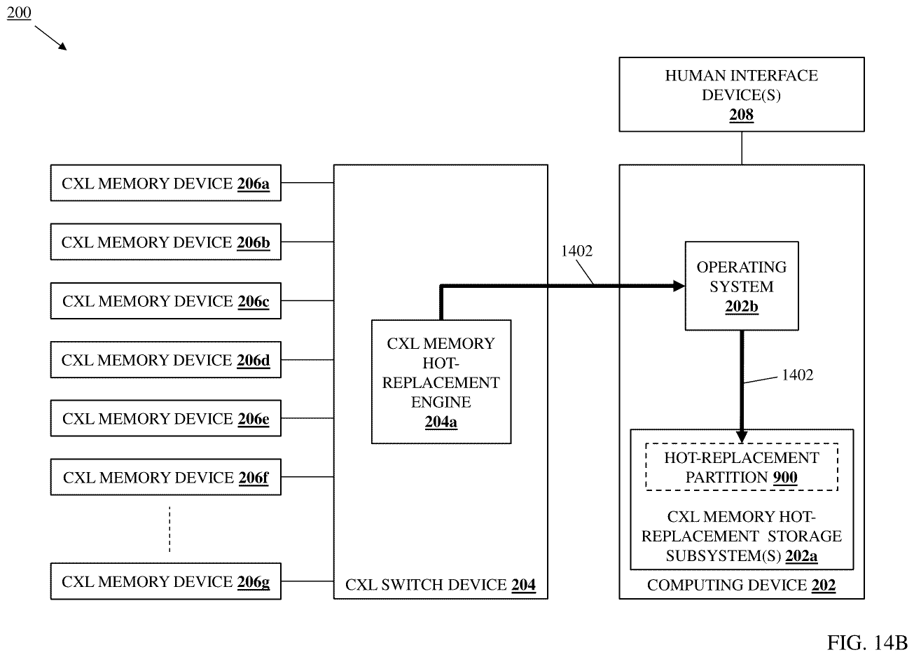

With reference to FIG. 14A, in an embodiment of block 716 and following the execution of the cached write instruction in the hot-replacement partition 900, the CXL memory hot-replacement engine 204a in the CXL switch device 204 may perform write instruction receiving operations 1400 that may include receiving write instructions from the operating system 202b that are directed to the CXL memory device 206b, and one of skill in the art in possession of the present disclosure will appreciate how workload(s) running on the computing device 202 may utilize the operating system 202b to direct write instructions to the CXL memory device 206b. With reference to FIG. 14B, at block 706 and in response to receiving the write instructions, the CXL memory hot-replacement engine 204a in the CXL switch device 204 may perform data write operations 1402 that may include transmitting data included in the write instruction to the operating system 202b to cause the operating system 202b to write that data to the hot-replacement partition 900. As will be appreciated by one of skill in the art in possession of the present disclosure, the CXL switch device 204 may continue to execute read instructions and write instructions directed to the CXL memory device 206b from the hot-replacement partition 900 until the replacement of the CXL memory device 206b has been completed.

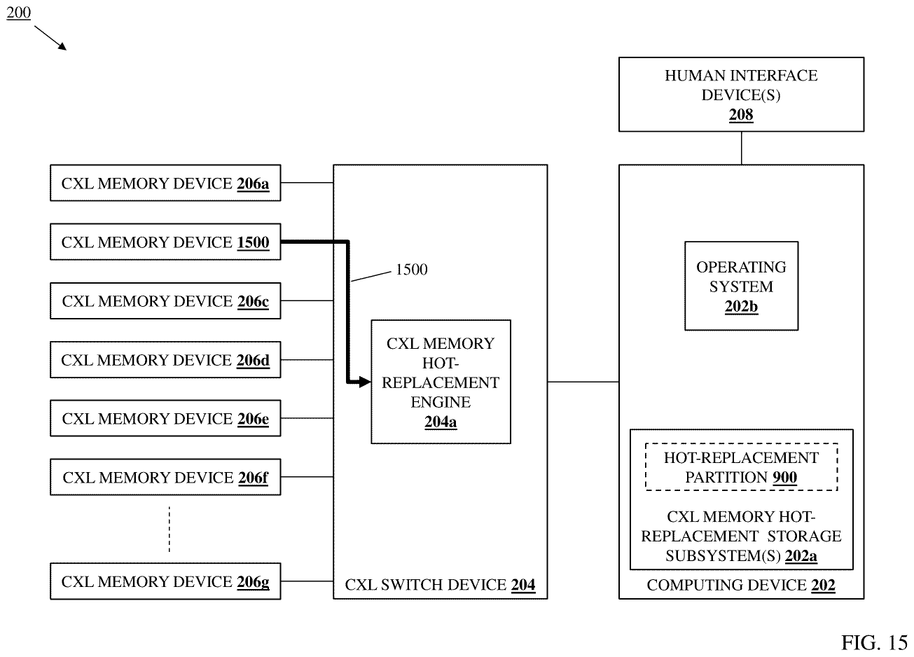

The method 700 then proceeds to block 718 where the CXL switch device receives a hot-replacement notification that the first CXL memory device has been replaced by a replacement CXL memory device. With reference to FIG. 15, in an embodiment of block 718, the CXL memory device 206b may be replaced by a CXL memory device 1500. For example, a user receiving the hot-plug notification may remove the CXL memory device 206b from the CXL memory system (e.g., by disconnecting (i.e., “hot removing”) the CXL memory device 206b from a first CXL memory device slot) and replace the CXL memory device 206b with the CXL memory device 1500 (e.g., by connecting (i.e., “hot plugging”) the CXL memory device 1500 to the first CXL memory device slot) without powering down the CXL memory system or otherwise making the CXL memory system unavailable such that it may continue to be utilized by workload(s) running on computing device(s) as described above.

Furthermore, at block 718, the CXL memory hot-replacement engine 204a in the CXL switch device 204 may perform hot-replacement notification receiving operations 1500 that may include receiving a hot-replacement notification that identifies that the CXL memory device 1500 has been added to the CXL memory system (e.g., connected (i.e., “hot-plugged”) to the first CXL memory device slot as described above). In some examples, the hot-replacement notification may include replacement CXL memory device characteristics for the CXL memory device 1500 that are described below as including a memory capacity of the CXL memory device 1500, but that may include any replacement CXL memory device characteristics that would be apparent to one of skill in the art in possession of the present disclosure. However, one of skill in the art in possession of the present disclosure will appreciate how the CXL switch device 204 may retrieve the replacement CXL memory device characteristics for the CXL memory device 1500 in response to receiving the hot-plug notification while remaining within the scope of the present disclosure as well.

The method 700 then proceeds to decision block 720 where the method 700 proceeds depending on whether the capacity of the replacement CXL memory device is less than the capacity of the first CXL memory device. In an embodiment, at decision block 720, the CXL memory hot-replacement engine 204a in the CXL switch device 204 may perform memory capacity comparison operations that include comparing the memory capacity of the CXL memory device 1500 to the memory capacity of the CXL memory device 206b. As such, one of skill in the art in possession of the present disclosure will appreciate how the CXL memory hot-replacement engine 204a may be coupled to a CXL memory hot-replacement database that stores the memory capacity of the CXL memory device 206b, and in which the CXL memory hot-replacement engine 204a stored the memory capacity of the CXL memory device 1500, so that the CXL memory hot-replacement engine 204a may compare those memory capacities.

If, at decision block 720, the capacity of the replacement CXL memory device is less than the capacity of the 1^{st} CXL memory device, the method 700 proceeds to block 722 where the CXL switch device prevents the replacement CXL memory device from being used to replace the first CXL memory device and generates an incompatible replacement CXL memory device notification. In an embodiment, at decision block 720, the memory capacity comparison operations by the CXL memory hot-replacement engine 204a may determine that the memory capacity of the CXL memory device 1500 is less than the memory capacity of the CXL memory device 206b, which one of skill in the art in possession of the present disclosure will recognize may prevent the copying of all the data from the hot-replacement partition 900 to the CXL memory device 1500 as described below, could cause issues with regard to the configuration of the operating system 202b or applications running on the computing device 202, and/or cause other memory capacity modification issues known in the art if the replacement CXL memory device with a lower memory capacity is used to replace the replaced CXL memory device.

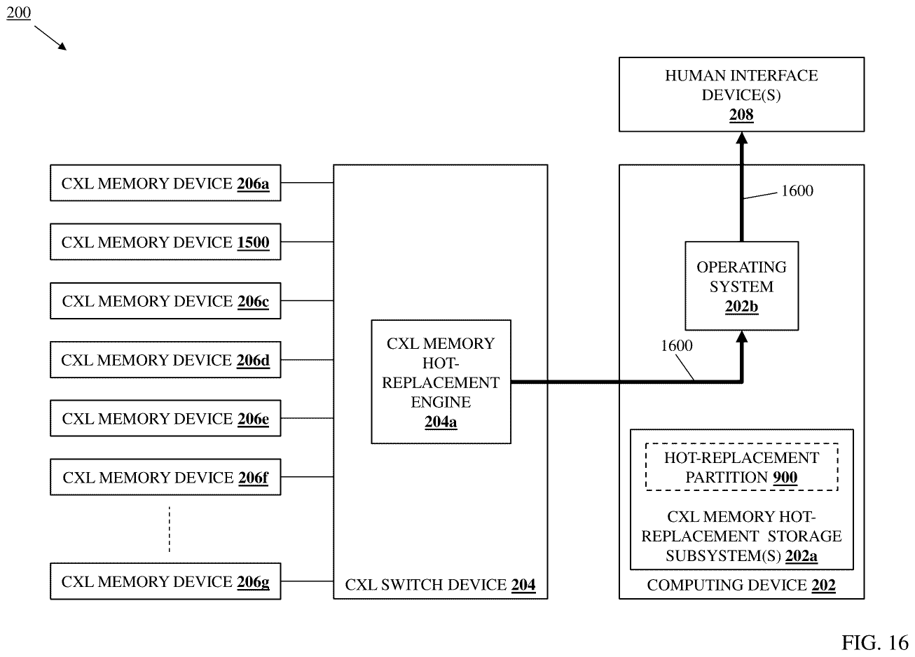

With reference to FIG. 16, at block 722 and in response to determining that the memory capacity of the CXL memory device 1500 is less than the memory capacity of the CXL memory device 206b, the CXL memory hot-replacement engine 204a in the CXL switch device 204 may prevent the use of the CXL memory device 1500 in the CXL memory system, and may perform incompatible replacement CXL memory device notification operations 1600 that include transmitting an incompatible replacement CXL memory device notification to the operating system 202b to cause the operating system 202b to transmit the incompatible replacement CXL memory device notification to the human interface device(s) 208. For example, the operating system 202b may provide the incompatible replacement CXL memory device notification for display to a user via the CXL memory management GUI discussed above (e.g., the CXL memory management GUI used to provide the hot-replacement request), with the incompatible replacement CXL memory device notification notifying the user that the CXL memory device 1500 that has been provided to replace the CXL memory device 206b in the CXL memory system has a lower memory capacity than the CXL memory device 206b, any issues that may result from that memory capacity deficiency, as well as any other incompatible replacement CXL memory device information that would be apparent to one of skill in the art in possession of the present disclosure.

The method 700 then returns to block 718. As such, the method 700 may loop such that replacement CXL memory devices with lower memory capacity than the CXL memory device they are replacing are prevented from being utilized in the CXL memory system, and corresponding incompatible replacement CXL memory device notifications are provided until a replacement CXL memory device is provided with a memory capacity that is greater than or equal to the memory capacity of the CXL memory device it is replacing. However, while described as requiring a replacement CXL memory device with a memory capacity that is greater than or equal to the memory capacity of the CXL memory device it is replacing, one of skill in the art in possession of the present disclosure will appreciate how some embodiments of the present disclosure may allow a replacement CXL memory device with a memory capacity that is less than the CXL memory device it is replacing to be utilized in the CXL memory system such as, for example, when a user receiving the incompatible replacement CXL memory device notification discussed above authorizes the use of that replacement CXL memory device, when the memory capacity of the replacement CXL memory device is sufficient to store the data that was copied to the hot-replacement partition 900 at block 706, and/or in other scenarios that would be apparent to one of skill in the art in possession of the present disclosure. As will be appreciated by one of skill in the art in possession of the present disclosure and as discussed above, changes in the memory capacity of the CXL memory system can cause issues with the operation of the computing device 202, so in embodiments in which a user authorizes the use of a lower-memory-capacity replacement memory device, a message may be displayed to a user (e.g., “memory performance may be impacted at maximum memory loads”) to inform them of those possible issues.

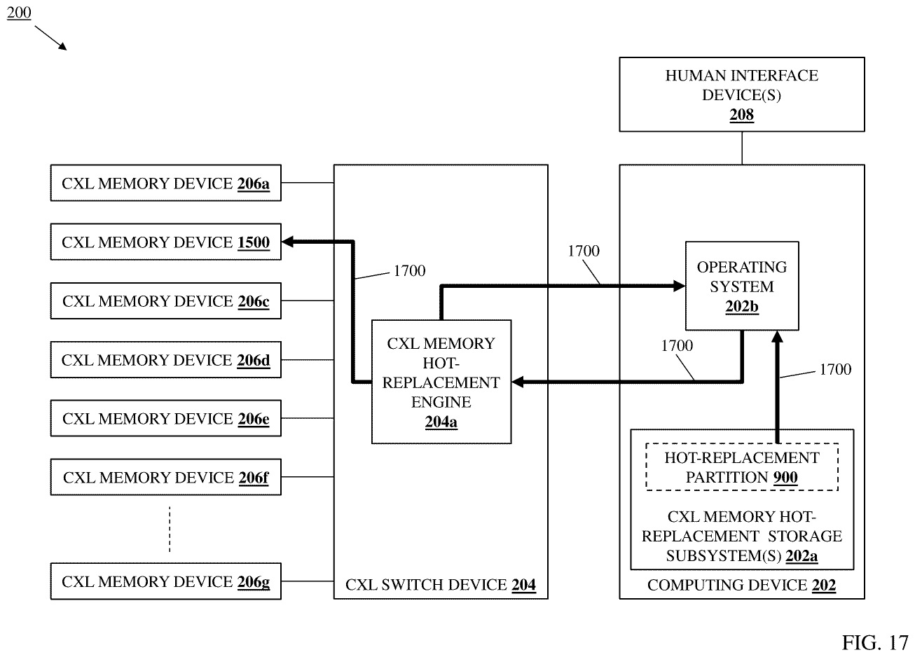

If, at decision block 710, the capacity of the replacement CXL memory device is greater than or equal to the capacity of the 1^{st} CXL memory device, the method 700 proceeds to block 724 where the CXL memory device copies the data from the hot-replacement partition to the replacement CXL memory device. With reference to FIG. 17, in an embodiment of block 724 and in response to determining that the memory capacity of the CXL memory device 1500 is greater than or equal to the memory capacity of the CXL memory device 206b (or in response to any of the scenarios discussed above that allow a replacement CXL memory device with a memory capacity that is less than the CXL memory device it is replacing to be utilized in the CXL memory system), the CXL memory hot-replacement engine 204a in the CXL switch device 204 may perform data copy operations 1700 that include providing a request to the operating system 202b to retrieve the data from the hot-replacement partition 900 to cause the operating system 202b to read the data from the hot replacement partition 900 and transmit that data to the CXL memory hot-replacement engine 204a, and writing that data to the CXL memory device 1500.

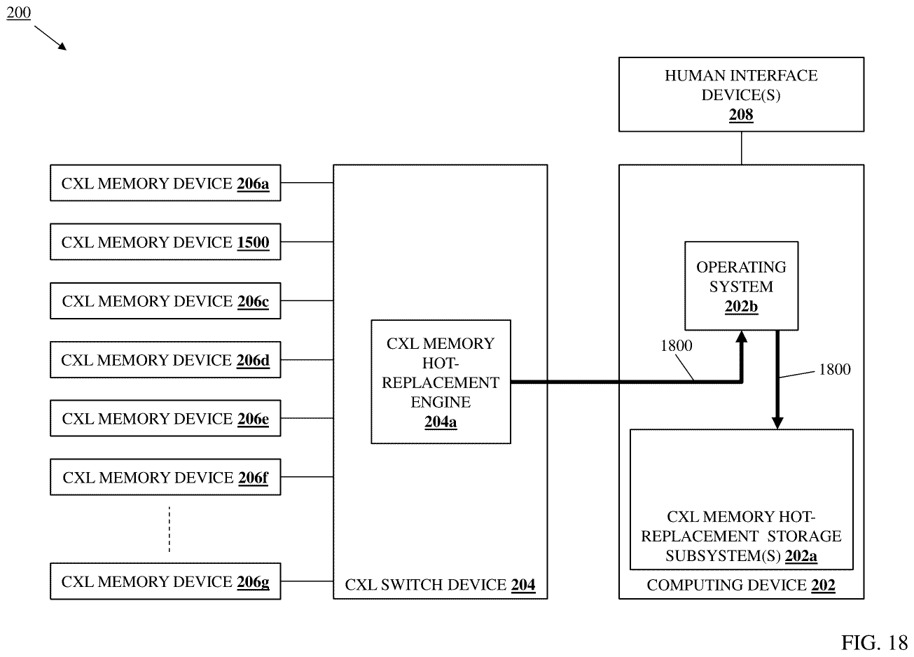

With reference to FIG. 18, following the completion of the data copy operations 1700 such that all of the data has been copied from the hot-replacement partition 900 to the CXL memory device 1500, the CXL memory hot-replacement engine 204a may perform hot-partition removal operations 1800 that include instructing the operating system 202b to remove the hot-removal partition 900 from the CXL memory hot-replacement storage subsystem(s) 202a to cause the operating system 202b to remove the hot-removal partition 900 from the CXL memory hot-replacement storage subsystem(s) 202a, which one of skill in the art in possession of the present disclosure will appreciate returns the storage space in the CXL memory hot-replacement storage subsystem(s) 202a that was used for the hot-removal partition 900 to the operating system 202b for any desired use.

The method 700 then proceeds to block 726 where the CXL switch device utilizes the replacement CXL memory device in the CXL memory system. In an embodiment, at block 726 and following the completion of the data copy operations 1700, the CXL memory hot-replacement engine 204a may use the CXL memory device 1500 in the CXL memory system for any of a variety of CXL memory operations in substantially the same manner as the CXL memory device 206b was used prior to its replacement.

Thus, systems and methods have been described that provide for the “hot-replacement” of CXL memory devices in a CXL memory system. For example, the CXL memory hot-replacement system of the present disclosure may include a CXL switch device coupling a computing device to a CXL memory system including a first CXL memory device. The CXL switch device receives a hot-replacement request that identifies the first CXL memory device for hot-replacement and, in response, creates a hot-replacement partition in a storage subsystem. The CXL switch device then copies data present in the first CXL memory device to the hot-replacement partition while caching write instruction(s) received for the first CXL memory device and, following the completion of the data copying, executes the write instruction(s). The CXL switch device then receives a notification that the first CXL memory device has been replaced by a second CXL memory device and, in response, it copies the data from the hot-replacement partition to the second CXL memory device, and utilizes the second CXL memory device in the CXL memory system. As such, CXL memory devices in a CXL memory system may be replaced faster than in conventional CXL memory systems and while providing no disruptions to workloads using the CXL memory system.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A memory hot-replacement system, comprising:
a computing device;
a memory system including a first memory device that is configured to communicate according to a Compute Express Link protocol; and
a switch device that couples the computing device to the first memory device and that is configured to communicate according to a Compute Express Link protocol, wherein the switch device is configured to:
receive a hot-replacement request that identifies the first memory device for hot-replacement;
create, in response to receiving the hot-replacement request, a hot-replacement partition in a storage subsystem that is accessible to the computing device;
copy data present in the first CXL-memory device to the hot-replacement partition;
cache, while copying the data present in the first memory device to the hot-replacement partition, one or more write instructions received for the first memory device;
execute, in the hot-replacement partition following the completion of the copying of the data present in the first memory device to the hot-replacement partition, the one or more write instructions that were received for the first memory device and cached;
receive a first hot-replacement notification that the first memory device has been replaced by a second memory device that is configured to communicate according to the Compute Express Link protocol;
copy, in response to receiving the first hot-replacement notification, the data from the hot-replacement partition to the second memory device; and
utilize the second memory device in the memory system.

2. The system of claim 1, wherein the switch device is configured to:
remove, from the storage subsystem following the copying of the data from the hot-replacement partition to the second memory device, the hot-replacement partition.

3. The system of claim 1, wherein the switch device is configured to:
receive, prior to receiving the first hot-replacement notification, a second hot-replacement notification that the first memory device has been replaced by a third memory device that is configured to communicate according to the Compute Express Link protocol;
identify, in response to receiving the second hot-replacement notification that the first memory device has been replaced by a third memory device, a third memory device capacity of the third memory device; and
determine that the third memory device capacity of the third memory device is less than a first memory device capacity of the first memory device and, in response, prevent the third memory device from being used to replace the first memory device.

4. The system of claim 3, wherein the switch device is configured to:
generate, in response to determining that the third memory device capacity of the third memory device is less than a first memory device capacity of the first memory device, an incompatible replacement memory device notification.

5. The system of claim 1, wherein the switch device is configured to:
execute, following the execution in the hot-replacement partition of the one or more write instructions that were received for the first memory device and cached, and prior to completing the copying of the data from the hot-replacement partition to the second memory device, read instructions and write instructions that are directed to the first memory device from the hot-replacement partition.

6. The system of claim 5, wherein the switch device is configured to:
generate, following the completion of the copying of the data present in the first memory device to the hot-replacement partition, a memory device hot plug instruction.

7. An Information Handling System (IHS), comprising:
a processing system; and
a memory system that is coupled to the processing system and that includes instructions that, when executed by the processing system, cause the processing system to provide a memory hot-replacement engine that is configured to:
receive a hot-replacement request that identifies a first memory device in a memory system for hot-replacement, wherein the first memory device is configured to communicate according to the Compute Express Link protocol;
create, in response to receiving the hot-replacement request, a hot-replacement partition in a storage subsystem that is coupled to the processing system;
copy data present in the first memory device to the hot-replacement partition;
cache, while copying the data present in the first memory device to the hot-replacement partition, one or more write instructions received for the first memory device;
execute, in the hot-replacement partition following the completion of the copying of the data present in the first memory device to the hot-replacement partition, the one or more write instructions that were received for the first memory device and cached;
receive a first hot-replacement notification that the first memory device has been replaced by a second memory device that is configured to communicate according to the Compute Express Link protocol;
copy, in response to receiving the first hot-replacement notification, the data from the hot-replacement partition to the second memory device; and
utilize the second memory device in the memory system.

8. The IHS of claim 7, wherein the memory hot-replacement engine is configured to:
remove, from the storage subsystem following the copying of the data from the hot-replacement partition to the second memory device, the hot-replacement partition.

9. The IHS of claim 7, wherein the memory hot-replacement engine is configured to:
identify, in response to receiving the first hot-replacement notification that the first memory device has been replaced by the second memory device, a second memory device capacity of the second memory device; and
determine that the second memory device capacity of the second memory device is at least equal to a first memory device capacity of the first memory device and, in response, copy the data from the hot-replacement partition to the second memory device.

10. The IHS of claim 7, wherein the memory hot-replacement engine is configured to:
receive, prior to receiving the first hot-replacement notification, a second hot-replacement notification that the first memory device has been replaced by a third memory device that is configured to communicate according to the Compute Express Link protocol;
identify, in response to receiving the second hot-replacement notification that the first memory device has been replaced by a third memory device, a third memory device capacity of the third memory device; and
determine that the third memory device capacity of the third memory device is less than a first memory device capacity of the first memory device and, in response, prevent the third memory device from being used to replace the first memory device.

11. The IHS of claim 10, wherein the memory hot-replacement engine is configured to:
generate, in response to determining that the third memory device capacity of the third memory device is less than a first memory device capacity of the first CXL memory device, an incompatible replacement memory device notification.

12. The IHS of claim 7, wherein the memory hot-replacement engine is configured to:
execute, following the execution in the hot-replacement partition of the one or more write instructions that were received for the first memory device and cached, and prior to completing the copying of the data from the hot-replacement partition to the second memory device, read instructions and write instructions that are directed to the first memory device from the hot-replacement partition.

13. The IHS of claim 12, wherein the memory hot-replacement engine is configured to:
generate, following the completion of the copying of the data present in the first memory device to the hot-replacement partition, a memory device hot plug instruction.

14. A method for hot-replacing memory, comprising:
receiving, by a switch device that is configured to communicate according to a Compute Express Link protocol, a hot-replacement request that identifies a first memory device in a memory system for hot-replacement, wherein the first memory device is configured to communicate according to the Compute Express Link protocol;
creating, by the switch device in response to receiving the hot-replacement request, a hot-replacement partition in a storage subsystem;
copying, by the switch device, data present in the first memory device to the hot-replacement partition;
caching, by the switch device while copying the data present in the first memory device to the hot-replacement partition, one or more write instructions received for the first memory device;
executing, by the switch device in the hot-replacement partition following the completion of the copying of the data present in the first memory device to the hot-replacement partition, the one or more write instructions that were received for the first memory device and cached;
receiving, by the switch device, a first hot-replacement notification that the first memory device has been replaced by a second memory device that is configured to communicate according to the Compute Express Link protocol;
copying, by the switch device in response to receiving the first hot-replacement notification, the data from the hot-replacement partition to the second memory device; and
utilizing, by the switch device, the second memory device in the memory system.

15. The method of claim 14, further comprising:
removing, by the switch device from the storage subsystem following the copying of the data from the hot-replacement partition to the second memory device, the hot-replacement partition.

16. The method of claim 14, further comprising:
identifying, by the switch device in response to receiving the first hot-replacement notification that the first memory device has been replaced by the second memory device, a second memory device capacity of the second memory device; and
determining, by the switch device, that the second memory device capacity of the second memory device is at least equal to a first memory device capacity of the first memory device and, in response, copying the data from the hot-replacement partition to the second memory device.

17. The method of claim 14, further comprising:
receiving, by the switch device prior to receiving the first hot-replacement notification, a second hot-replacement notification that the first memory device has been replaced by a third memory device that is configured to communicate according to the Compute Express Link protocol;
identifying, by the switch device in response to receiving the second hot-replacement notification that the first memory device has been replaced by a third memory device, a third memory device capacity of the third memory device; and
determining, by the switch device, that the third memory device capacity of the third memory device is less than a first memory device capacity of the first memory device and, in response, preventing the third memory device from being used to replace the first memory device.

18. The method of claim 17, further comprising:
generating, by the switch device in response to determining that the third memory device capacity of the third memory device is less than a first memory device capacity of the first memory device, an incompatible replacement memory device notification.

19. The method of claim 14, further comprising:
executing, by the switch device following the execution in the hot-replacement partition of the one or more write instructions that were received for the first CXL memory device and cached, and prior to completing the copying of the data from the hot-replacement partition to the second memory device, read instructions and write instructions that are directed to the first memory device from the hot-replacement partition.

20. The method of claim 14, further comprising:
generating, by the switch device following the completion of the copying of the data present in the first memory device to the hot-replacement partition, a memory device hot plug instruction.
